(19) United States
(12) Patent Application Publication
(10) Pub. No.: US 2009/0058201 A1
(43) Pub. Date: Mar. 5, 2009

(54) RECIPROCATING ELECTRICAL MACHINE

(75) Inventor: Jon Eirik Brennvall, Trondheim (NO)

Correspondence Address: DENNISON, SCHULTZ & MACDONALD, 1727 KING STREET, SUITE 105, ALEXANDRIA, VA, 22314, US

(73) Assignee: RESONATOR AS, Trondheim (NO)

(21) Appl. No.: 12/281,646

(22) PCT Filed: Feb. 28, 2007
(86) PCT No.: PCT/NO2007/000083

§ 371 Date: Oct. 7, 2008

(30) Foreign Application Priority Data
Mar. 9, 2006 (NO) 2006 1136

(51) Int. Cl. H02K 33/16

(52) U.S. Cl. 310/31; 310/15

(57) ABSTRACT

Method for transforming energy in a reciprocating electric machine, particularly a motor or generator. An electrically operated linear movable piston oscillates between two springs. The energy in the springs is at least five times larger than the energy transferred between the piston and the electrical system for each cycle of the machine. A reciprocating electric machine comprises a linear movable piston 15, which is arranged in a tubular cylinder 11 to operate as a working element. It is provided with magnetic elements, which establish an outwardly directed electrical field of force, which is effective towards a surrounding row of tubular, coils 22. At each end of the cylinder 11 is formed a spring which forms a resonance-effective arrangement. The interaction between the magnetic fields of the coils 22 and the magnetic elements 16, respectively, obtain energy transmission between the coils and the piston 15.

The present invention relates to a reciprocating electric machine as described in the introduction to claim 1, particularly for ground and subsea drilling and oil well interventions.

### BACKGROUND

For several purposes, a linear, reciprocating electric machine is demanded, particularly for powering equipment in wells and similar narrow places. It may be hammers for drilling or compacting, compressors and pumps.

A further area of use for reciprocating electric machines is for generating electric power through oscillations.

Common to these areas of application is a limited input or output for each oscillation of the reciprocating element.

It is known linear motors operated like vibrators, which are used to power drilling equipment for drilling in the ground or subsea, at offshore locations.

In U.S. Pat. No. 5,060,737 (Mohn, 1991) a drilling system is described wherein a linear motor element is driven reciprocably to axially load a drill bit. The means for transfer of the energy from the linear motor to the drill bit did not allow for a sufficient high power conversion.

In German patent publication 39 10 266 (Bihler 1990) a chisel system is described, with a linear motor operating like a hammer against a chisel bit.

### OBJECT

The main object of the invention is to provide a linear electric machine with improved power to weight/volume ratio to prior art devices. The power efficiency shall be comparable to other electric machines.

A particular object is to provide a linear vibrator with improved efficiency, for use as a hammer for drilling or compacting on narrow spaces.

### THE INVENTION

The method according to the invention, for transforming energy in a reciprocating electric machine, comprises an electrically operated linear movable piston which oscillates between a system of two gas springs, the energy in the spring system being at least five times larger than the energy transferred between the piston and the electrical system for each cycle of the machine, the energy of the spring system being the sum of the pressure difference between the springs and the kinetic energy of the piston. Due to this method, the machine will have a unique resonant behaviour. This will be different from the operation of prior art machines, e.g. working as a vibrators or hammers, where a gas spring is loaded before the energy is transferred to the piston when a trigger mechanism is released. The piston then gives away all its energy in a collision before it is taken to its initial position while the spring is reloaded.

The kinetic energy is given by the formula ½ mv2, where m is the mass of the piston and v the speed of the piston. When the pressure in the gas springs are equal al the energy in the mass spring system is in the form of kinetic energy. Due to this feature, the novel machine will have a relative heavy piston compared to its housing. This is necessary to store the energy since the energy is proportional to the mass and the speed is limited to what bearings can stand. Since the heavy piston moves at large speed a very stiff spring is needed to store the kinetic energy when the piston is decelerated, and give the piston back its energy when accelerated in the opposite direction. This spring is provided by a closed volume on each side of the piston filled with pressurized gas. These types of springs are called gas springs, and their stiffness, max stroke length and ability to store energy is much larger then mechanical springs of same size. Large speed of the piston is necessary to get high power (P) since P=Fv where F is the electric force and v is speed.

Further details of the method are described in claims 2 and 3. The method may have a piston is operating in a tubular cylinder as a working element in a motor or a generator and being provided with magnetic elements which establish an outwardly directed electrical field of force, which is acting towards a surrounding row of tubular coils, where at each end of the cylinder, and where the interaction between the magnetic fields of the coils and the magnetic elements respectively provide energy transmission between the electrical energy in the coils and the mechanical energy of the axial movement of the piston in the cylinder. The machine is preferable operated at an oscillation frequency of 8-500 Hz.

The machine according to the invention is described in claim 4, claims 5-11 stating advantageous features of this machine.

The invention may be based on the technology described in PCT-application NO05/00035. This publication is describing a working machine with an electromechanical converter, with a linear movable piston which is arranged in a tubular cylinder to operate as a working element in a motor. It is provided with magnetic elements which establish an outwardly directed electrical field of force, which is effective towards a surrounding row of tubular coils. At each end of the cylinder is formed a gas spring which forms a resonance-effective arrangement. The interaction between the magnetic fields of the coils and the magnetic elements respectively obtain energy transmission between the electrical energy in the coils and the mechanical energy of the axial movement of the piston in the cylinder. The cylinder is closed to form tight end chambers. At each end of the piston there is formed a gas spring of high pressure. The piston supports a row of centrally placed tubular permanent magnets or alternative coils. The cylinder comprises a row of coordinated coils or alternative permanent magnets for increasing the machine's piston area and/or the piston's length of stroke. (P=Fv˜Ffl where f is frequency and l is stroke length. means proportional)

The vibrator comprises a piston which slides inside a housing (a tube which is closed in both ends). The space inside the housing which is not filed by the piston is filled by pressurized gas. The piston sealing prevents gas from leaking from one side of the piston to the other. The gas will this way work as a stiff spring between. The gas spring is so stiff that the natural frequency of the piston will be high in spite of the pistons relative large weight. The gas spring will be considerably stiffer then a spring of steel with same dimensions. The gas spring design also allows the piston a long stroke length. This is unique for this machine, and is the key to the machine's high power.

A screw spring or magnetic spring can be arranged at each end of the cylinder as a supplement to the gas springs for holding the piston in position when the machine is turned off.

The piston consists of iron and magnets. Coils are an integrated part of the housing wall. By sending current trough the coils an electric force will act between the tube and the piston. By controlling the current so the electric force and speed of the piston has the same direction the electric force will be in forced resonance with the mass-(gas)spring system.

Because of the resonance a relative small electric force will after some time give a long stroke length of the piston at high frequency because of the stiff gas springs. This is equivalent with large speed of the piston. This is essential since power in this type of machines is proportional to the electric force multiplied with speed.

It presents new technical development primary with application hammer drill in rock and wire line jar. A wire line jar is a hammer on the end of a wire which is used to beat loose, move or fasten objects. It is a tool much used in oil industry for recovery or replacement of objects like e.g. valves in oil wells.

The energy in the mass spring system must be larger than the energy supplied to the machine between each stroke. This distinguishes the invention from hammers where a gas spring is charged hydraulic or electric before all the energy is transferred to a piston when a trigger mechanism is released. The piston then gives away all its energy in a collision before it is taken to its initial position while the gas spring is charged again.

### EXAMPLE

The invention will be described in more detail with reference to the drawings, in which

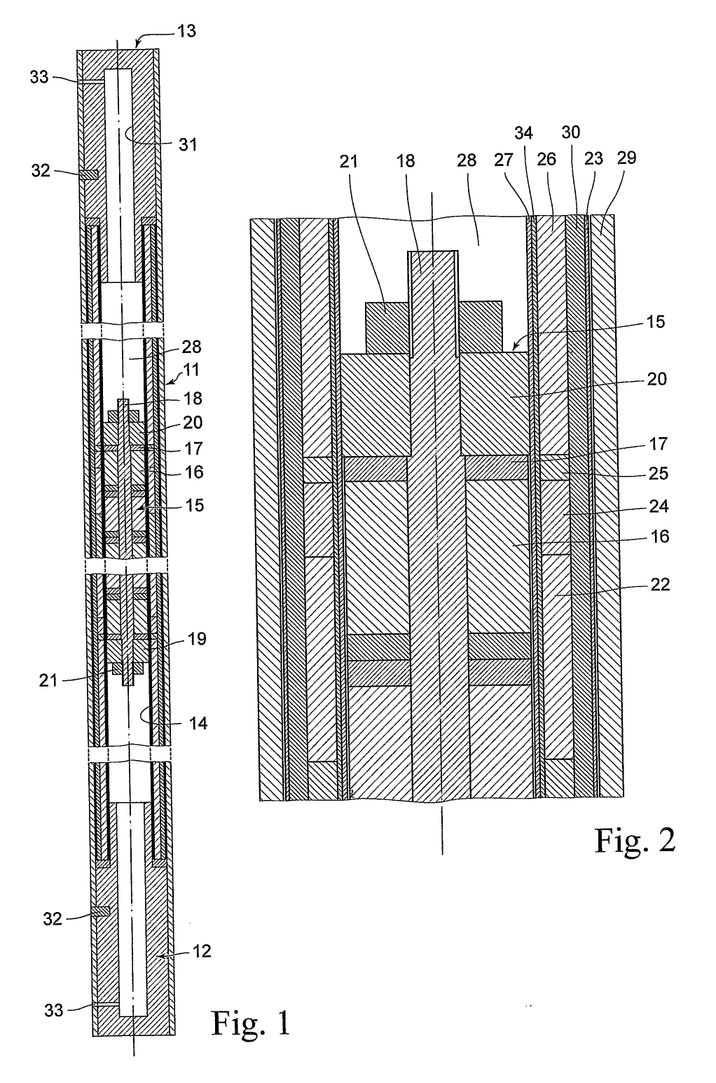

FIG. 1 shows a longitudinal section through an embodiment of a linear electric vibrator according to the invention,

FIG. 2 shows an enlarged segment of the vibrator of FIG. 1,

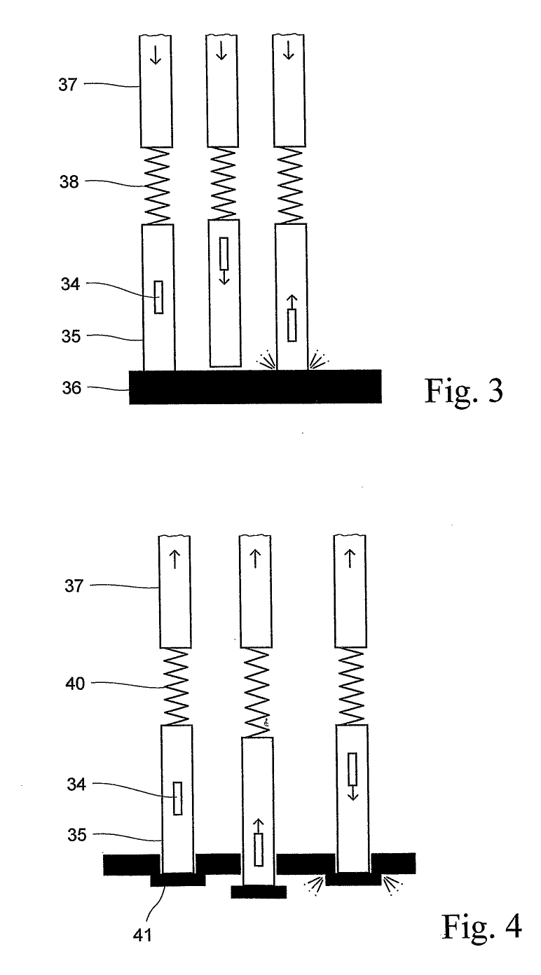

FIG. 3 shows a schematically side view of an application of the vibrator in FIG. 1, while

FIG. 4 shows a schematically side view of a further application of the vibrator in FIG. 1.

The embodiment of the invention shown in FIGS. 1 and 2 comprises an outer tubular housing 11 with a lower end closure 12 and an upper end closure 13. The terms “lower” and “upper” are connected to the shown position of the housing 11 on the figures. The machine of the figures can be rotated in any direction. The tubular housing 11 is providing a cylinder wall 14 accommodating the active element of the vibrator, which is a piston 15 being longitudinally movable in the housing 11 in a manner described below.

The piston 15 is a longitudinal assembly of alternating permanent magnet rings 16 and intermediate soft iron rings 17 on a central steel rod 18 with sealing ring 19 and 20 at the ends. This design purpose is to make a magnetic field with alternating direction which is perpendicular to the piston movement direction. Other design which gives such an alternating field is possible.

The assembly of rings 16-20 is joined by end nuts 21 on the central steel rod 18. The sealing rings 19 and 20 of a material engaging the cylinder wall 14 in a sealing manner. The magnet rings 16 and the soft iron rings 17 are making an air gap to the cylinder wall 14 to reduce friction. The diameter of said rings can thus be without extreme accuracy.

The number of sealing rings has to be adapted to the length of the tubular housing, a larger number than two may be necessary. Additional sealing rings may replace soft iron rings or be arranged additionally.

The main element of the tubular housing 11 is a series of tubular coils 22 of copper wire connected to an electric power source. The coils 22 are wrapped in a sheath 23 of axial wires of sheet metal being bonded to the coils 22 by glue. The sheath 23 is extending over the end extensions of the coils 22, being assembled by a tubular distance piece 24 of a non-metal material, e.g. plastic, closest to the end coils 22, followed by a ring 25 of iron and a tubular end sleeve 26 lining the ends of the tubular housing 11. The tubular end sleeves 26 can be manufactured of reinforced plastic, ceramics or other non electric conducting material, incorporating the connections to the tubular coils 22. A purpose of the end sleeves 26 is to take the forces created when the end chambers 28 of the cylinder inside the tubular housing 11 are acting as a gas spring. Replacing the gas spring by another kind of spring will give an uneconomical large spring with today's material technology.

A machine with mechanic, magnetic etc. springs in addition to the gas spring is the same machine as described here because the springs will not significant change the behaviour of the machine during operation. The iron ring 25 is actually a magnetic spring, but the purpose of this “spring” is to keep the piston in centre position when the machine is turned off. A screw spring inside the gas spring can have a similar purpose. Such springs can be used as position sensors for control purposes.

The inner wall of the assembly of coils 22 and tubular end elements 24-26 are covered by a lining 27 of a low friction material, e.g. PEEK (PolyEtherEtherKetone) or Teflon (trademark).

The tubular housing 11 is covered by an outer steel tube 29 extending to cover the end closure 12 and 13. The sheath 23 is embedded inside reinforced plastic 30 to hold it tighter. The parts 22-28 and 30 are placed inside a tube 29. The space between the reinforced plastic 30 and 29 the tube can be filled with glue or oil to improve heat transfer out of the machine in radial direction.

The end closures 12 and 13 are metal plugs with an inner bore 31 providing an extension of the end chambers 28. The end closures are sealed against the inside of the lining 27 with suitable sealing elements.

The outer steel tube 29 is fastened to the end closures by bolts 32. An other alternative is threads on part 12, 13 and 29.

Gas is let into the end chambers 28 trough valves 33 and similar on the other side. The valve vill be closed during operation, and the gas let inn will then be the gas spring.

### Manufacturing

The lining 27 may be prepared as a standalone element, on which the coils 22 are embedded in a layer or matrix 34 of resin with a non conductive fibre material, e.g. glass fibre. Then the end sleeves 26 are prepared by adding fibres and matrix material. To provide a tight fit for this thin lining 27, it is a tube with smaller inner diameter which can resist deformation. Matrix of resin, coils etc (part 22-26,34,30) are then glued outside the tube. The lining tube is then cut inside to the right diameter. The other parts give sufficient strength so the lining 27 keeps it close fit.

### Function and Use

It is significant to the invention that the energy in the spring system is at least five times larger than the energy transferred between the piston and the electrical system for each cycle of the machine. The energy of the spring system being the sum of the difference between the spring forces and the kinetic energy of the piston.

In FIG. 3 a hammer system based on a vibrator 34 according to the invention is shown during operation in three phases. The vibrator 34 is arranged inside a drilling tool 35, e.g. for offshore drilling, the bottom of the hole having the reference numeral 36. The drilling tool 35 is connected to a substantially larger mass 37 by a screw spring 38. This spring may also be arranged inside the drilling tool 35, acting against the end of the vibrator 34.

When the piston is accelerated down, the counter force will lift the housing from the object 36 acted upon. When the piston 15 accelerates up again, the housing crashes dawn on the ground 36 again. Almost no energy goes through the spring 38 to the larger mass 37.

FIG. 4 shows the system of FIG. 3 used for lifting. In this case, the spring 40 is extended by the vibrator 34. The object 41 can be an object inside an oil well which shall be replaced, but which is stuck to the walls of the well. The spring 40 can be the entire wire in a wire line operation. This system can be the basis for e.g. a wire line jar.

Rings of iron direct the magnet field from the magnets through the coils to the back iron.

Special care is taken to avoid circular currents trough the parallel wires. The walls of the chambers 28 should be non-conducting to avoid eddy currents.

The electric vibrator according to the invention can be uses for multiple onshore and offshore purposes, e.g. as a pulling tool, as a seismic source, as a hammer, as a jar, as a pile driver and as a compressor. For this purpose one of the end pieces 12, 13 are provided to engage with a power transfer element, particularly a hammer.

A screw spring or magnetic spring may be arranged at each end of the cylinder inside the upper end chamber 28, as a supplement to the gas springs, for holding the piston in position when the machine is turned off. Additional spring solutions can be magnetic springs based on magnets placed so they repel each other or springs based on attraction between magnets and iron,

What is claim is:

1. Method for transforming energy in a reciprocating electric machine, particularly a motor or generator, comprising an electrically operated linear movable piston which oscillates between a system of two springs, characterized in that the energy in the spring system is at least five times larger than the energy transferred between the piston and the electrical system for each cycle of the machine, the energy of the spring system being the sum of the difference between the spring forces and the kinetic energy of the piston.

2. Method according to claim 1, characterized in that the piston (15) is operating in a tubular cylinder (11) as a working element in a motor or a generator and being provided with magnetic elements which establish an outwardly directed electrical field of force, which is acting towards a surrounding row of tubular coils (22), where at each end of the cylinder (11), and where the interaction between the magnetic fields of the coils (22) and the magnetic elements (16) respectively provide energy transmission between the electrical energy in the coils and the mechanical energy of the axial movement of the piston (15) in the cylinder (11).

3. Method according to claim 1, characterized in that the machine is operated at a oscillation frequency of 8-500 Hz.

4. Reciprocating electric machine, particularly for a motor or generator, comprising a linear movable piston (15) which is arranged in a tubular cylinder (11) to operate as a working element in a motor or a generator and which is provided with magnetic elements which establish an outwardly directed electrical field of force, which is effective towards a surrounding row of tubular coils (22), where at each end of the cylinder (11) is formed a spring which forms a resonance-effective arrangement, and where the interaction between the magnetic fields of the coils (22) and the magnetic elements (16) respectively obtain energy transmission between the electrical energy in the coils and the mechanical energy of the axial movement of the piston (15) in the cylinder (11), characterized in that the energy in the spring system is at least five times larger than the energy transferred between the piston (15) and the electrical system for each cycle of the machine.

5. Reciprocating electric machine according to claim 4, characterized in that the spring at each end of the cylinder is a gas spring.

6. Reciprocating electric machine according to claim 4, characterized in that a screw spring or magnetic spring is arranged at each end of the cylinder as a supplement to the gas springs for holding the piston in position when the machine is turned off.

7. Reciprocating electric machine according to claim 4, for use as a vibrator or compacter, characterized in that the free ends of the cylinder (11) has end elements (12, 13) for force transfer, one of which is for transfer of force between the electrical machine and an operational member and the second (13) between the vibrator and a spring device (38).

8. Reciprocating electric machine according to claim 4, characterized in that a central connection rod (18) is arranged to hold together the elements (16, 17, 20) of the piston (15).

9. Reciprocating electric machine according to claim 4, characterized in that the end elements (12, 13) for force transfer are connected by an outer tubular housing (29).

10. Reciprocating electric machine according to claim 9, characterized in that the ends of the tubular housing (29) is lined with a non-conducting material (26) which has an inner low friction sleeve (27) defining the wall (14) of the cylinder for the piston (15).

11. Reciprocating electric machine according to claim 10, characterized in that the coils (22) arranged on the low friction sleeve (27) have back iron outside them to prevent circular currents in the tubular housing (29).
